(19) United States
(12) Patent Application Publication
(10) Pub. No.: US 2011/0168034 A1
(43) Pub. Date: Jul. 14, 2011

(54) Brown sugar softener steamer

(76) Inventor: Rebecca Mizell, New York, NY (US)

(21) Appl. No.: 12/930,194

(22) Filed: Dec. 31, 2010

Related U.S. Application Data
(60) Provisional application No. 61/335,077, filed on Dec. 31, 2009.

(51) Int. Cl. A47J 27/04

(52) U.S. Cl. 99/450

(57) ABSTRACT

The Brown Sugar Softener Steamer provides a two-piece set, consisting of a steaming vessel and a universal pot-lid. The universal pot-lid is sized in a variety of sizes to cover any sized pot. The lid is manufactured of stamped metal, oval or round in shape, and is equipped with two sturdy handles, positioned opposite one another on the circumference of the lid. In the center of the pot-lid is an oval or rounded opening. This opening is designed to receive the steaming vessel, which sits inside the pot-lid from above and rests on a lip on the edge of the insert. The steaming vessel can be manufactured of stamped metal, or of heat-resistant, microwave-safe injection molded plastic. The steaming vessel (insert) has a diameter of approximately six and six-eighths inches and height of approximately three inches. The bottom of the insert is solid, as well as one-half inch from the bottom of the insert and the remainder of the insert is perforated through out the entire circumference. The top of the vessel is surmounted with an outward-bending lip and two oppositely-placed, sturdy handles. The steaming-vessel is designed to fit snugly within the opening in the pot-lid.

### CLAIM OF PRIORITY

This patent application claims priority under 35 USC 119 (e) (1) from U.S. Provisional Patent Application Ser. No. 61/335,077 filed Dec. 31, 2009, of common inventorship herewith entitled, “Brown Sugar Softener Steamer.”

### FIELD OF THE INVENTION

The present invention pertains to the field of food preparation and more specifically to the field of food steamers and even more specifically to the field of food steamers suitable for softening hardened brown sugar.

### BACKGROUND OF THE INVENTION

The prior art has put forth several designs for food steamers suitable for re-hydrating or softening hardened brown sugar. Among these are:

U.S. Pat. No. 4,013,869 to Maria Amelia Orts describes a tortilla warmer and hydrator comprising a container, rack and heating element.

U.S. Pat. No. 6,875,959 to Edward Ciejek describes a food steamer comprising a large vessel and integral heating element.

U.S. Pat. No. 4,982,656 to Earlyn Stone describes a steamer comprising a steaming vessel and food tray. This device requires an external heating element.

U.S. Pat. No. 5,865,104 to John C. K. Sham and Kumkit Kunavong Vorakul describes a food steamer comprising a removable food steaming cabinet and water supply tank and steaming tray.

None of these references describe the present invention.

### BRIEF DESCRIPTION OF THE DRAWINGS

FIG. 1 shows a front perspective view of the present invention showing the insert in the raised position.

FIG. 2 shows a front perspective view of the present invention showing the insert in the lowered position.

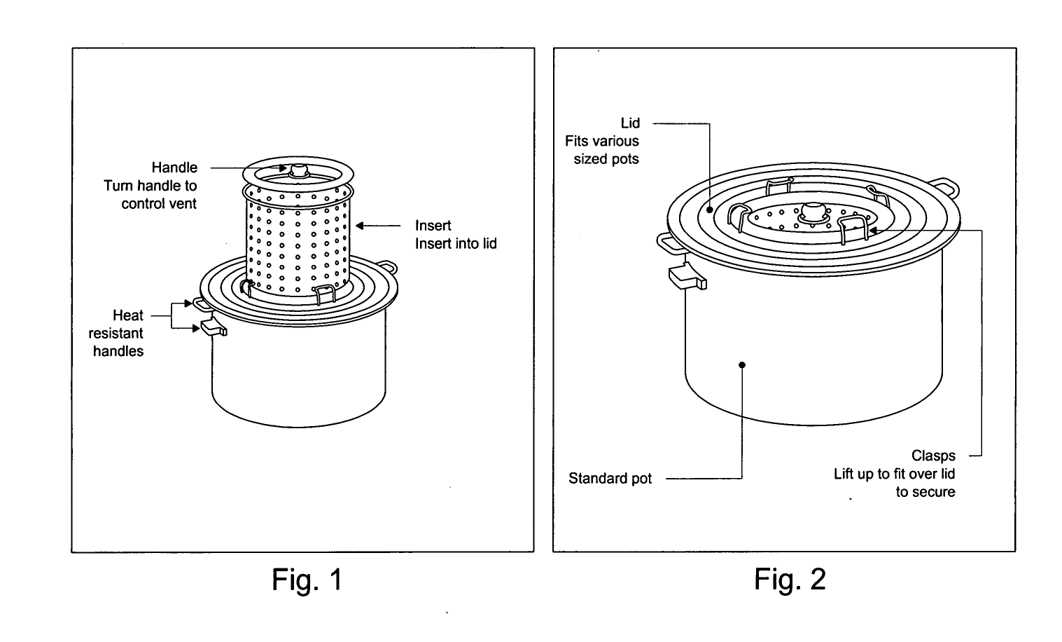

### DETAILED DESCRIPTION OF THE INVENTION

Sugars are water-soluble, crystalline carbohydrates that can supply energy to living things. Common table sugar is sucrose. Other sugars include fructose, found in fruits; lactose, found in milk; and glucose, the most common sugar in the bodies of animals and plants. The process of making sugar, evaporating cane juice was discovered about 500 BC, in India. Two hundred years later, one of Alexander the Great's commanders in India witnessed this process, and described the sugarcane as “a reed that gives honey without bees.” Originally, people chewed the cane raw to extract its sweetness. Sugar refining spread from India to China. Later, the Moors brought sugar refining to the Middle East, North Africa and Spain; and the Crusaders brought the first refined sugar home from the Holy Land to Europe. They called it “sweet salt.” Sugarcane thrived in South and Central America and the Caribbean, where the European powers established colonies based on sugarcane cultivation and refining, powered first by Indian and then African slavery.

Meanwhile, Europeans had discovered a second source for refined sugar, the sugar beet. With cane sugar or beet sugar, the refining process involves crushing the plants for their juice, then treating the juice to remove impurities, the sugar crystallizing through stages as the juice is evaporated.

White granulated refined sugar is the pure end-product, while brown sugar has significant molasses content. Brown sugar can also be made by mixing cane molasses with refined white sugar. The color and taste of brown sugars become stronger with increasing molasses content, as do their moisture retaining properties. White sugar has one flavor only, the primary taste-sensation, sweet. Brown sugar, which combines sweet with the flavor of cane molasses, is a more complex substance, highly valued for everything, from sweetening oatmeal to a long list of cookie recipes. Unlike white sugar, brown sugar has one serious drawback: it will dry out and harden if exposed to the atmosphere.

Recognizing the need of householders and other cooks for a way to restore hard brown sugar to its original consistency, the present invention, hereinafter referred to the Brown Sugar Softener Steamer was developed. Simply stated, the Brown Sugar Softener Steamer comprises a two-piece set, consisting of a steaming vessel and a universal pot-lid. The universal pot-lid is sized in a variety of sizes to cover any sized pot. The lid is manufactured of stamped metal, oval or round in shape, and is equipped with two sturdy handles, positioned opposite one another on the circumference of the lid. In the center of the pot-lid is an oval or rounded opening. This opening is designed to receive the steaming vessel, which sits inside the pot-lid from above and rests on a lip on the edge of the insert. The steaming vessel can be manufactured of stamped metal, or of heat-resistant, microwave-safe injection molded plastic. The steaming vessel (insert) has a diameter of approximately six and six-eights inches and height of approximately three inches. The bottom of the insert is solid, as well as one-half inch from the bottom of the insert and the remainder of the insert is perforated through out the entire circumference. The top of the vessel is surmounted with an outward-bending lip and two oppositely-placed, sturdy handles. The steaming-vessel is designed to fit snugly within the opening in the pot-lid. Hardware on the lid, doubles as a knob and a manual vent that regulates the amount of steam released.

Use of the Brown Sugar Softener Steamer is quite simple and straightforward. Stove-top use requires a cooking pot large enough to accommodate both the Brown Sugar Softener Steamer, and an inch or two of water. The cook simply fills the pot with an inch or two of water, and then sets it to heat on the stove. Meanwhile, the cook prepares the steaming-vessel. Taking a package of hardened brown sugar, the cook opens the sugar, removes it from its plastic bag and places the sugar “brick” in the bottom of the steaming vessel. Next, the cook places the universal pot-lid over the pot on the stove, and then lowers the steaming vessel into the opening in the middle of the pot-lid. As the water begins to steam and boil in the pot, steam will rise and is contained by the pot-lid. This steam will enter the steaming-vessel through the many perforations in its sides, and in two minutes the brown sugar will be soft, re-hydrated, and malleable.

Alternatively, the Brown Sugar Softener Steamer, in a microwave-safe plastic version, can be used similarly in a microwave oven. Here, the pot-lid is not necessary, as the microwave itself will contain the steam from the bowl or pot which holds both a small volume of water and the steaming-vessel.

The Brown Sugar Softener Steamer, a handy and unique cooking accessory, presents a number of distinct and significant benefits and advantages over the prior art. Foremost, the Brown Sugar Softener Steamer quickly restores hardened brown sugar to its natural, original consistency and malleability. In a manner of minutes the Brown Sugar Softener Steamer effectively spares harried householders and cooks the necessity of interrupting their cooking with a last-minute run to the store for a new package of brown sugar.

The Brown Sugar Softener Steamer, however, is far more than a single-use appliance. The Brown Sugar Softener Steamer also functions as an efficient steaming-vessel for fresh vegetables and other foodstuffs. With the Brown Sugar Softener Steamer on the stove-top or in the microwave, one easily steams a batch of hot fluffy rice, pre-mixed rice-and-beans or rice-and-sauce dishes, for example.

Further, re-hydration of overly dried fruits, for another example, is easily accomplished with the Brown Sugar Softener Steamer. With the versatile Brown Sugar Softener Steamer, one can even create exotic dishes such as poached pears, steamed artichokes, and the like, without undertaking the purchase of a separate rice-cooker or electric steamer.

Both the steaming-vessel and the pot-lid of the Brown Sugar Softener Steamer are dishwasher safe. The Brown Sugar Softener Steamer requires no special care or extra maintenance, and easily provides many years of trouble-free, reliable service. The Brown Sugar Softener Steamer, a simple two-piece steaming-vessel and dedicated, universal pot-lid, functions as either a stove-top or microwave steamer for softening hardened brown sugar, and for steaming a wide variety of fruits, vegetables, or starches. Compact and adaptable, the Brown Sugar Softener Steamer is useful with virtually any large cooking pot on the stove-top, or with any large bowl in the microwave. Innovative, versatile, surprisingly affordable and easy to clean and store, the Brown Sugar Softener Steamer will find a wide and receptive market.

Although this invention has been described with respect to specific embodiments, it is not intended to be limited thereto and various modifications which will become apparent to the person of ordinary skill in the art are intended to fall within the spirit and scope of the invention as described herein taken in conjunction, with the accompanying drawings and the appended claims.

1. A brown sugar softener steamer, comprising a steaming vessel and a lid, having two handles positioned opposite one another on the circumference of the lid, and wherein the center of the lid is an oval or rounded opening, wherein the opening receives a steaming vessel, which steaming vessel sits inside the lid from above and rests on a lip on the edge of an insert, wherein the steaming vessel has an insert having a diameter of approximately six and six-eighths inches and height of approximately three inches, and wherein the bottom of the insert is solid, as well as one-half inch from the bottom of the insert is solid, and wherein the remainder of the insert is perforated through out the entire circumference, and wherein the top of the vessel is surmounted with an outward-bending lip and wherein the steaming-vessel is designed to fit snugly within the opening in the lid.

2. The brown sugar softener steamer of claim 1 wherein the steaming vessel is manufactured of stamped metal, or of heat-resistant, microwave-safe injection molded plastic.

3. The brown sugar softener steamer of claim 2 wherein the steaming vessel insert has a diameter of approximately six and six-eighths inches and height of approximately six inches.

4. The brown sugar softener steamer of claim 2 wherein the lid is manufactured of stamped metal, is oval or round in shape, and is equipped with two sturdy handles, positioned opposite one another on the circumference of the lid.

5. The brown sugar softener steamer of claim 2 wherein the steaming vessel is manufactured of stamped metal, or of heat-resistant, microwave-safe injection molded plastic.
